(19) United States
(12) Patent Application Publication
(10) Pub. No.: US 2025/0374856 A1
(43) Pub. Date: Dec. 11, 2025

(54) ZIPPERED RIDING LAWN MOWER BAG THAT SIMPLIFIES EMPTYING THE GRASS AND A METHOD OF MAKING THE SAME

(71) Applicant: Stuart Jonathan Singer, Cazenovia, NY (US)

(72) Inventor: Stuart Jonathan Singer, Cazenovia, NY (US)

(21) Appl. No.: 19/229,469

(22) Filed: Jun. 5, 2025

Related U.S. Application Data
(60) Provisional application No. 63/656,699, filed on Jun. 6, 2024.

(51) Int. Cl. A01D 43/063; A01D 101/00

(52) U.S. Cl. CPC A01D 43/063; A01D 2101/00

(57) ABSTRACT

A method of improving the collection bag of a riding lawn mower is disclosed. The method includes defining a flap along a rear panel of the collection bag by way of an attachment path, wherein a detachable fastener is operatively associated with the attachment path. The attachment path extends adjacent to at least one side edge and one of a top edge and bottom edge of the rear panel to define the flap so that it is movable between a closed condition and an open condition defining a debris outlet entirely below the bagger attachment of the riding lawn mower. The detachable fastener operatively associated with the attachment path enables users to secure the flap in the closed condition or unsecure the flap to move it to the open condition for removing debris from the collection bag through the outlet without disengaging the collection bag from the bagger attachment.

### CROSS REFERENCE TO RELATED APPLICATION

This application claims the benefit of priority of U.S. provisional application number 63/656,699, filed Jun. 6, 2024, the contents of which are herein incorporated by reference.

### BACKGROUND OF THE SUBJECT DISCLOSURE

The subject disclosure relates to lawn maintenance and, more particularly, to a debris collection bag of riding lawn mower, wherein the debris collection bag provides a movable flap that simplifies emptying the grass, and a method of making 14 the same.

While mowing grass, for those who bag the resulting grass clippings, such debris collection bags can weigh over forty pounds, which makes it difficult to handle 17 much less lift such bags of grass out of the riding mower collection system.

This issue is acute for riding lawn mowers, since riding lawn mower grass collection bags are up to 4.7 bushels in volume and up to 100 lb if filled with moist, thick, grass. The only way to empty such grass collection bags requires lifting the bag up out of the frame and flipping it over to dump the grass out. This process is strenuous and is known to cause back and shoulder injuries. Interestingly, current grass bagging systems, for riding lawnmowers, blow the grass up a chute to then be discharged into the hanging bags, which begs the question: why lift the grass again after the mower has done it already?

As can be seen, there is a need for a debris collection bag with a movable flap that simplifies emptying the grass by eliminating that second lift.

### SUMMARY OF THE SUBJECT DISCLOSURE

By providing, in some embodiments, a U-shaped attachment path along a panel of the grass collection bag of a riding lawn mower and a detachable fastener 4 operatively associated with the attachment path, the subject disclosure enables a separatable or movable “flap” in the debris collection bag.

The portion of the panel of the debris collection bag that is defined by the U-shaped attachment path, making it movable relative to the remainder of the panel, thereby enables and defines, when the flap is moved, an outlet through which the grass can be easily pulled or pushed out by hand or with a modified trowel.

And as a result, the colloquially known “Back Saver Riding Mower Bag”, embodied in the subject disclosure, enables almost anyone that can operate the 12 riding mower to empty the operatively associated collection bags without the need to lift or even manipulate the collection bag or bags beyond detaching the fastener along the attachment path.

In one aspect of the present subject disclosure, a method of improving a debris collection bag of a riding lawn mower includes the following components: cutting a continuous attachment path along a rear panel of the debris collection bag, wherein the continuous attachment path is just inward of both back edges and a bottom edge, wherein a length of the continuous attachment path is sufficient to define a flap that is movable between a closed condition and an open condition defining an outlet in the rear panel, and wherein the back panel outlet is as large as possible to facilitate emptying of compacted clippings; and operatively associating a detachable fastener to the continuous attachment path for moving the closed condition between a locked engagement and an unlocked engagement enabling movement to the open condition, whereby debris is removable from the debris collection bag via the outlet without lifting the debris collection bag from the bagger attachment, wherein the continuous attachment path is below a bagger attachment of the riding lawn mower when the debris collection bag is engaged to the bagger attachment and collecting debris from use of the riding lawn mower, whereby debris is removable from the debris collection bag via the outlet without disengaging the debris collection bag from the bagger attachment, wherein the continuous attachment path defines a U-shape, wherein a base of the U-shape is adjacent to the bottom edge or wherein the continuous attachment path defines a U-shape, wherein a base of the U-shape is adjacent to the top edge, and wherein the detachable fastener is a coil zipper.

In another aspect of the present subject disclosure, a debris collection bag system for a riding lawn mower includes the following components: the riding lawn mower; one or more bagger attachments operatively associated with the riding lawn mower, wherein each bagger attachment is configured to hang a debris collection bag in an upright position while urging debris into an upper opening of the debris 12 collection bag; for each debris collection bag, a continuous attachment path along a rear panel thereof, wherein the continuous attachment path is just inward of at least one side edge and one of a top edge and a bottom edge, wherein a length of the continuous attachment path is sufficient to define a flap that is movable between a closed condition and an open condition defining an outlet in the rear panel, and wherein the outlet is at least two square feet in area; and a detachable fastener operatively associated with the continuous attachment path for moving the closed condition between a locked engagement and an unlocked engagement enabling movement to the open condition for removing debris from the debris collection bag via the outlet without disengaging the debris collection bag from the bagger attachment, wherein the entire continuous attachment path is below a bottom-most portion of bagger attachment, wherein the continuous attachment path defines a U-shape or wherein a base of the U-shape is adjacent to the bottom edge, wherein the continuous attachment path defines a U-shape, wherein a base of the U-shape is adjacent to the top edge, and wherein the detachable fastener is a coil zipper.

These and other features, aspects and advantages of the present subject disclosure will become better understood with reference to the following drawings, description and claims.

### BRIEF DESCRIPTION OF THE DRAWINGS

FIG. 1 is a perspective view of an exemplary embodiment of the subject disclosure shown in use, illustrating the attachment path of each grass collection bag 10 that defines the respective flap 30 in a closed condition.

FIG. 2 is a perspective view of an exemplary embodiment of the subject disclosure, illustrating the flap 30 associated with the attachment path in an open condition.

FIG. 3 is a cutaway perspective view of an exemplary embodiment of the collection bag 10, illustrating the flap 30 in the closed condition, containing the debris within the collection bag 10.

FIG. 4 is a cutaway perspective view of an exemplary embodiment of the collection bag 10, illustrating the flap 30 in the open condition for removing the debris 18.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

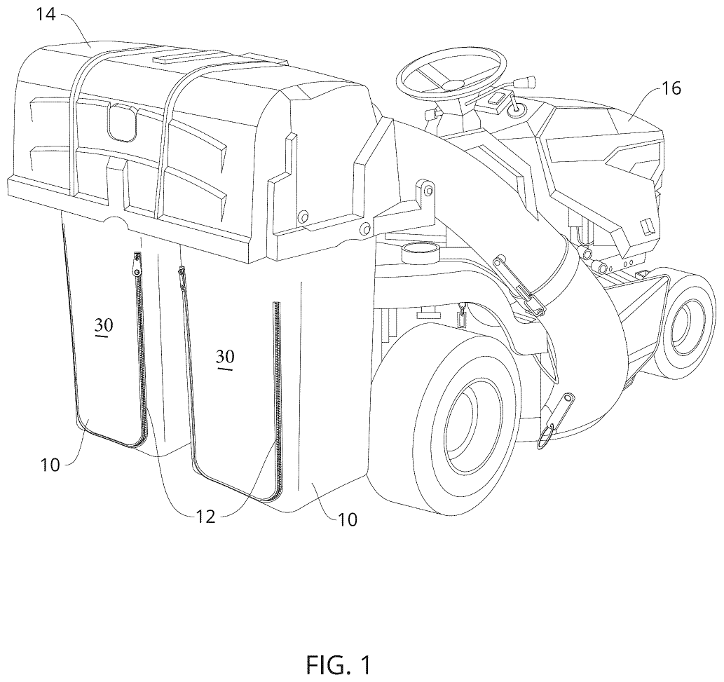

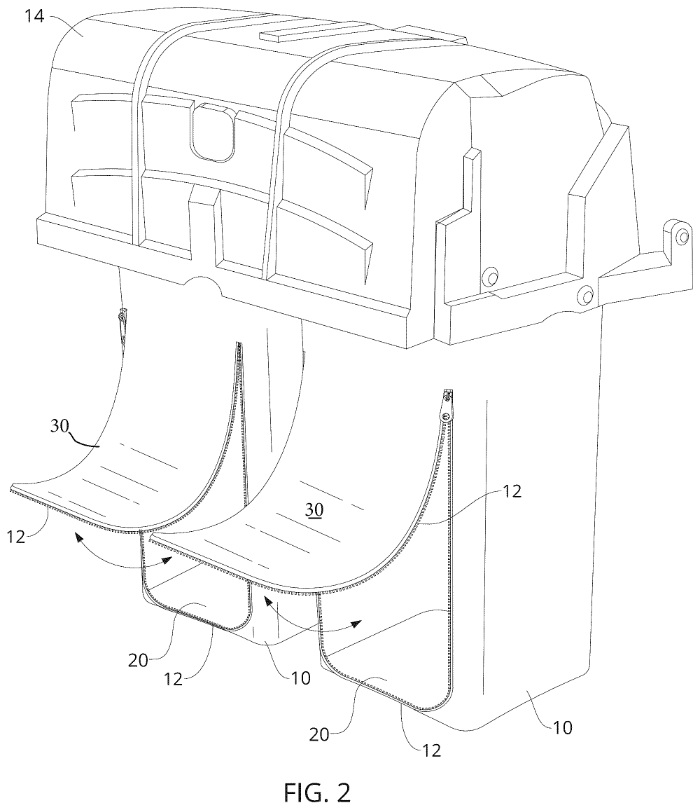

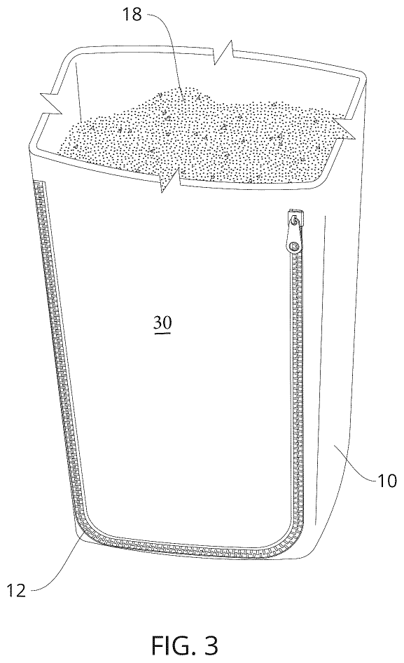

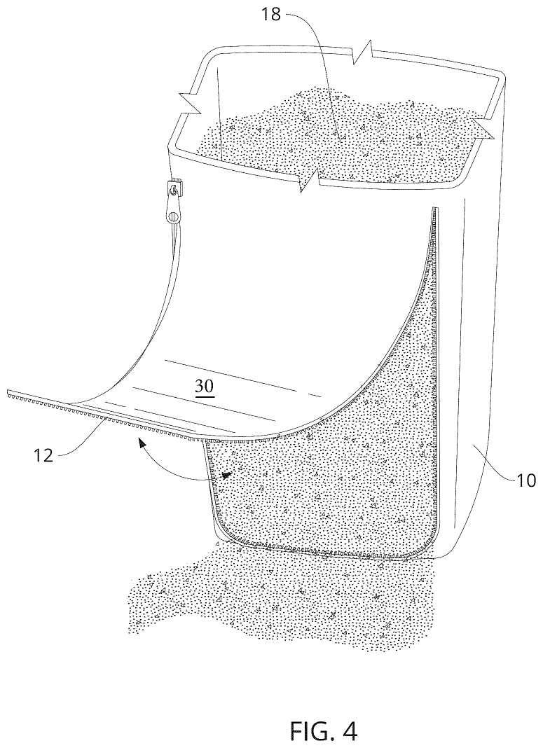

Referring now to FIGS. 1 through 4, the subject disclosure may include a debris collection bag 10 of a riding lawn mower 16 that simplifies emptying the collected debris 18 through providing a movable flap 30.

The inventive debris collection bag 10 may be made from a commercially available debris collection bag, removed from its metal frame of a bagger attachment 14 of the riding mower 16. Thus, the subject disclosure contemplates a method of improving a debris collection bag through the following steps: cutting a portion of a panel of the debris collection bag to define the movable flap 30, wherein the perimetral edges of the movable flap 30 are defined by this cut line or “attachment path”. The shape of the attachment path need not be a symmetrical U-shape, if the attachment path defines the movable flap 30 such that in an open condition the debris 18 within the debris collection bag 10 can be relatively easily removed by hand or a hand tool. Typically, the attachment path is just inward a bottom edge and two side edges of a rear panel of the modified debris collection bag. The distance associated with ‘just inward’, in some embodiments, is not less than ½ inch and not more than one inch from the vertical edges of the panel/collection bag. In other embodiments, that distance is as close to the side edges as possible, otherwise clippings may not be emptied as easily as it otherwise would through the outlet.

Then a manufacturer can attach a detachable fastener 12 along the attachment path. In some embodiments, the detachable fastener 12 may be a zipper (though snaps or hook and pile fastener may be used if the attachment they form is sufficiently strong to prevent unintended rupture of detachment). In some embodiments, the zipper may be a heavy-duty coil zipper. Then the manufacturer may trim loose fabric prior to placing the subject debris collection bag 10 back in the bagger attachment 14 of the riding mower 16.

In operation, when debris 18 needs to be removed from the debris collection bag 10, the user detaches (e.g., unzips) the detachable fastener 12 along the entirety or substantially entirety of the attachment path so that the debris collection bag 10 is in the open condition. In the open condition, the movable flap 30 may be peeled away so that the debris 18 of the debris collection bag 10 may be emptied via the outlet opened by peeling away the movable flap 30. At that point, the user would pull out the grass clippings 18 by hand or with modified trowel. Then the user may rezip the bag after emptying and resuming cutting the lawn. At the bottom of the debris collection bag 10 is the standard plastic bottom that riding mower bags are constructed with.

In some embodiments, in part based on the path cut by the attachment path, moving the detachable fastener 12 to the open condition allows the rear-facing (relative to the riding lawn mower 16) panel of the debris collection bag 10—i.e., the movable flap 30—to be self-moving because of the lateral force exerted due to weight of the debris 18 above, at a given point within the collection of debris 18 piled within the debris collection bag 10.

In such cases, the attachment path may be an upside-down U-shape. In some embodiments, an L-shaped attachment path, inward of the rear panel of the pre-existing collection bag, may be sufficient to define a movable flap for enabling the subject disclosure.

By cutting continuously along at least one side and a top portion or bottom portion, and thus the included corner, of a commercially available riding mower bag and installing a detachable fastener 12 along that attachment path, the advantageous subject disclosure is made.

As used in this application, the term “about” or “approximately” refers to a range of values within plus or minus 10% of the specified number. And the term “substantially” refers to up to 80% or more of an entirety. Recitation of ranges of values herein is not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affects the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A method of improving a debris collection bag of a riding lawn mower, the method comprising:
cutting a continuous attachment path along a rear panel of the debris collection bag, wherein the continuous attachment path is just inward of at least one side edge and one of a top edge and a bottom edge, wherein a length of the continuous attachment path is sufficient to define a flap that is movable between a closed condition and an open condition defining an outlet in the rear panel, and wherein the outlet is at least two square feet in area; and
operatively associating a detachable fastener to the continuous attachment path for moving the closed condition between a locked engagement and an unlocked engagement enabling movement to the open condition, whereby debris is removable from the debris collection bag via the outlet without lifting the debris collection bag from the bagger attachment.

2. The method of claim 1, wherein the continuous attachment path is below a bagger attachment of the riding lawn mower when the debris collection bag is engaged to the bagger attachment and collecting debris from use of the riding lawn mower, whereby debris is removable from the debris collection bag via the outlet without disengaging the debris collection bag from the bagger attachment.

3. The method of claim 2, wherein the continuous attachment path defines a U-shape, wherein a base of the U-shape is adjacent to the bottom edge.

4. The method of claim 2, wherein the continuous attachment path defines a U-shape, wherein a base of the U-shape is adjacent to the top edge.

5. The method of claim 3, wherein the detachable fastener is a coil zipper.

6. A debris collection bag system for a riding lawn mower, the debris collection bag system comprising:
the riding lawn mower;
one or more bagger attachments operatively associated with the riding lawn mower, wherein each bagger attachment is configured to hang a debris collection bag in an upright position while urging debris into an upper opening of the debris collection bag;
for each debris collection bag, a continuous attachment path along a rear panel thereof, wherein the continuous attachment path is just inward of at least one side edge and one of a top edge and a bottom edge, wherein a length of the continuous attachment path is sufficient to define a flap that is movable between a closed condition and an open condition defining an outlet in the rear panel, and wherein the outlet is at least two square feet in area; and
a detachable fastener operatively associated with the continuous attachment path for moving the closed condition between a locked engagement and an unlocked engagement enabling movement to the open condition for removing debris from the debris collection bag via the outlet without disengaging the debris collection bag from the bagger attachment.

7. The debris collection bag system of claim 6, wherein the entire continuous attachment path is below a bottom-most portion of bagger attachment.

8. The debris collection bag system of claim 7, wherein the continuous attachment path defines a U-shape, wherein a base of the U-shape is adjacent to the bottom edge.

9. The debris collection bag system of claim 7, wherein the continuous attachment path defines a U-shape, wherein a base of the U-shape is adjacent to the top edge.

10. The debris collection bag system of claim 7, wherein the detachable fastener is a coil zipper.
